(19) United States
(12) Patent Application Publication
(10) Pub. No.: US 2018/0047022 A1
(43) Pub. Date: Feb. 15, 2018

(54) METHOD AND SYSTEM FOR SECURED PROCESSING OF A CREDIT PAYMENT

(71) Applicant: DIAMOND SUN LABS, INC., Edmonton (CA)

(72) Inventor: Francisco SCHIPPERHEIJN, Edmonton (CA)

(21) Appl. No.: 15/550,709

(22) PCT Filed: Mar. 30, 2015
(86) PCT No.: PCT/CA2015/050245

§ 371 Date: Aug. 11, 2017

Related U.S. Application Data
(60) Provisional application No. 61/971,916, filed on Mar. 28, 2014.

(51) Int. Cl. G06Q 20/40; G06Q 20/34; G06Q 20/24

(52) U.S. Cl. CPC G06Q 20/4012; G06Q 20/24; G06Q 20/352

(57) ABSTRACT

Methods and a system are provided for secured processing of a credit transaction. The method comprises receiving from a customer interface device a credit request for a transaction account having a zero credit, the credit request comprising a credit amount and a customer security input; verifying the customer security input; and conditional upon verifying the customer security input: (i) debiting an offline credit account by the credit amount, and crediting the transaction account with the credit amount; and (ii) debiting the transaction account by the credit amount, and crediting a merchant account with the credit amount.

### FIELD OF THE INVENTION

The present invention relates to methods and systems for secured processing of credit payments.

### BACKGROUND OF THE INVENTION

Credit cards are used by customers to make purchases from merchants. A typical credit card shows the customer's name and signature, a 16-digit account number, and an expiry date. It is also common to have 3 or 4 digit security code which is imprinted on the card. Credit card transactions are commonly processed electronically using computing devices and communication networks to obtain and transmit information between the customer, merchant and card issuer, with or without physical use of the card itself.

Despite their convenience, credit cards are susceptible to unauthorized use as a result of theft of the physical credit card, or theft of relevant card account information through electronic fraud. For purchases made over the internet or telephone, the information that appears on the credit card is often sufficient to authorize the transaction without any further verification that the purchaser is the named customer. For purchases made in person, the merchant might compare the signature on the credit card to the purchaser's signature on the receipt, but the purchaser can easily forge the signature to pass a cursory inspection. For purchases made using electronic credit card terminals or computers, the purchaser may need to enter a personal identification number (PIN) or password, but this exposes the customer to the risk of the PIN or password being surreptitiously acquired by surveillance, card “skimming”, or “phishing” techniques.

Accordingly, there is a need in the art for improved methods and systems for secured processing of credit card payments that reduces the risk of unauthorized transactions. Such methods and systems should be simple and economical for card issuers to implement, and convenient for customers to use.

### SUMMARY OF THE INVENTION

The present invention provides a method and system for secured process of a credit payment. The description of a conventional credit card is an approved line of credit with purchases being deducted from the line of credit. In embodiments of the present invention, the credit card controls two separate accounts: a transaction account; and a concealed off-line credit account linked to the transaction account. The transaction account maintains a zero (0.00) available line of credit at all times. The transaction account requests the purchase amount from the concealed off-line (intranet) credit account only when an authenticated purchase transaction is initiated. The transaction account in turn transfers the purchase amount to the merchant, preferably upon completion of a further authentication step. After completing the purchase from the merchant the transaction account is returned back to a zero (0.00) available line of credit.

The request for the purchase funds and acceptance to transfer the purchase amount requires the positive execution of one or more identification and authentication processes. In one embodiment, these processes require input or identification of a security code, such as a PIN. For example, one of these processes requires the customer to input the relative complement of part of a PIN associated with account. Another process may require the customer to correctly input a variable that correctly identifies the position of a character within a portion of an account number that does not appear on the card. Another process may involve requesting a customer input of the transaction amount and comparing same to the requested fund amount by the merchant. These identification and authentication processes may be used individually or in combination for added security for credit transactions.

As such, theft of the credit card provides no value to the thief as of the information, such as the complete account number, is not displayed on the face of the card or embedded or encoded in a chip or magnetic swipe strip attached to the card. Also, this makes it almost impossible for any merchant to collect all of the customer's data or for a thief to physically duplicate the card. The account number may consist of any number of characters, preferably around 20 characters, of which 4 may be hidden.

These processes can be implemented to securely process a credit card payment in a variety of shopping situations, such as point-of-sale using the physical credit card, or in an online environment. In any case, all network communications carried out are encrypted. The methods and systems of the present invention can be adapted for use with conventional credit cards, with minimal changes to credit card processing infrastructure.

Therefore, in one aspect, the invention may comprise an authorization server system for secured processing of a credit payment, comprising:
at least one processor;
at least one memory component operatively connected to the at least one processor and storing a set of instructions executable by the at least one processor to cause the system to (a) receive a credit amount request and a customer security input from a customer interface device; (b) verify the customer security input; and, conditional upon verification, (c) debit an offline credit account by the credit amount and credit a zero balance transaction account by the credit amount.
   In one embodiment, the instructions executable by the at least one processor further cause the system to (d) receive a second customer security input; (e) verify the second customer security input; and, conditional upon verification, (f) debit the transaction account by the credit amount and credit a merchant account by the credit amount.

In one embodiment, the second customer security input comprises data presenting the value of the credit amount, and verification of the second customer security input comprises the step of verifying the value of the credit amount equals the balance of the transaction account.

In one embodiment, either the first or the second customer security input, or both, is a response to a request comprising a character set having one or more characters and a prompt for a customer security input to complete or validate the character set.

In one embodiment, the transaction account is associated with a transaction account identifier comprising a string of characters, each character having a position in the string; wherein the character set comprises at least one character randomly selected from the transaction account identifier, and the customer security input comprises data representative of the position of the at least one randomly selected character within the transaction account identifier.

In one embodiment, the transaction account is associated with a PIN set comprising a string of characters; wherein the character set comprises at least one character randomly selected from the PIN set, and the customer security input is an input comprising a relative complement of the at least one character of the PIN set in the character set.

In one embodiment, the instructions executable by the at least one processor further cause the system to persistently store customer-related information in the at least one memory component.

In one embodiment, the instructions executable by the at least one processor further cause the system to display an interface on the customer interface device for receiving shopping information describing goods or services to be purchased in the credit transaction and the request for the credit amount.

In one embodiment, the instructions executable by the at least one processor further cause the system to transmit to the merchant server, customer-related information and shopping information describing goods or services to be purchased in the credit transaction, upon the receipt of the request for the credit amount by the credit request receiving unit and the verification of the customer security input by the customer security input verification unit.

In one embodiment, the instructions executable by the at least one processor further cause the system to credit a writable emergency line of credit memory component of a credit card in communication with the customer interface device with the value of the credit amount request.

In one embodiment, the memory component of the credit card is readable and writable by the customer interface device, the memory component having information about an amount debited against an emergency line of credit; and wherein the instructions executable by the at least one processor further cause the system to receive the amount debited against the emergency line of credit and (i) to debit the offline credit account by the amount debited against the emergency line of credit and (ii) to cause the customer interface device to reset the amount debited against the emergency line of credit stored on the credit card to zero, upon verification of the customer security input by the customer security input verification unit.

In one embodiment, the customer interface device is one or more of: a computing device, a mobile computing device, a game console, a media player, a television, a cable box, and a satellite receiver.

In one embodiment, the instructions executable by the at least one processor further cause the system to cause the customer interface device to display simultaneously a customer interface in communication with the system adjacent to a merchant interface in communication with the merchant server.

In one embodiment, the instructions executable by the at least one processor further cause the system to import customer-related information into a merchant interface in communication with the merchant server, to store a template of the merchant interface having the customer-related information, and to provide a short-cut to the template via the customer interface device.

In another aspect, the invention may comprise a method of secured processing of a credit transaction, comprising the steps of:
(a) receiving from a customer interface device a credit request for a transaction account having a zero credit, the credit request comprising a credit amount and a customer security input;
(b) upon verification of the customer security input, debiting an offline credit account by the credit amount, and crediting a zero balance transaction account with the credit amount.

In one embodiment, the method may further comprise the step of receiving a second customer security input, and upon verification of the second customer security input, debiting the transaction account by the credit amount, and crediting a merchant account with the credit amount.

In one embodiment, the transaction account is associated with a transaction account identifier comprising a string of characters, each character having a position in the string; wherein the customer security input is a response to a character set which comprises at least one character randomly selected from the transaction account identifier, and the customer security input comprises data representative of the position of the at least one randomly selected character within the transaction account identifier.

In one embodiment, the transaction account is associated with a PIN set comprising a string of characters; wherein the customer security input is in response to a character set which comprises at least one character randomly selected from the PIN set, and the customer security input comprises data representative of a relative complement of the at least one character of the PIN set in the character set.

In one embodiment, the transaction account is associated with a PIN set comprising a plurality of characters, wherein the customer security input is in response to a character set which consists of at least one of but less than all of the characters of the PIN set, and the customer security input comprises data representative of the remaining characters in the PIN set.

In one embodiment, the method may further comprise the step of receiving from the merchant server a payment request for the merchant account, the payment request comprising a payment amount, and wherein one or both of: (i) debiting an offline credit account by the credit amount and crediting the transaction account with the credit amount; and (ii) debiting the transaction account by the credit and crediting the merchant account with the credit amount, are conditional upon verifying that the requested payment amount equals the requested credit amount.

In one embodiment, the method may further comprise the steps of:
persistently storing customer-related information;
providing for display by the customer interface device an interface enabling the customer to input shopping information describing goods or services to be purchased in the credit transaction, and to trigger the transmission of the shopping information and the credit request to the authorization server; and
in response to receiving the credit request, and conditional upon verifying the customer security input, transmitting to the merchant server the customer-related information and the shopping information.

In one embodiment, the method may further comprise the step of causing the customer interface device to display a customer interface adjacent to a merchant interface in communication with the merchant server.

In one embodiment, the method may further comprise the step of importing customer-related information into a merchant interface in communication with the merchant server; storing a template of the merchant interface having the customer-related information;

and providing a short-cut to the template via the customer interface device.

In another aspect, the invention may comprise a method for secured processing of an emergency credit card transaction, the method comprising:
providing the credit card with a physically integrated memory component for storing information about an amount debited against an emergency line of credit, wherein the memory component is readable and writable by a customer interface device;
receiving at an authorization server from the customer interface device via a network, the amount debited against the emergency line of credit as read from the memory component of the credit card, and a customer security input; and
verifying the customer security input; and
conditional upon verifying the customer security input:
   (i) debiting an offline credit account by the amount debited against the emergency line of credit; and
   (ii) resetting the amount debited against the emergency line of credit to zero.

In another aspect, the invention may comprise a memory comprising a recording medium having recorded thereon instructions, which when executed by a processor of an authorization server system in communication via a network with a customer interface device and a merchant server causes the system to carry out an embodiment of a method for secured processing of a credit payment as described herein.

In various embodiments, the invention provides methods and components or units, including persistent (or “non-transient”) machine-interpretable instruction sets, such as software, for implementing the various functions and processes described herein.

### BRIEF DESCRIPTION OF THE DRAWINGS

A further, detailed, description of the invention, briefly described above, will follow by reference to the following drawings of specific embodiments of the invention. These drawings depict only typical embodiments of the invention and are therefore not to be considered limiting of its scope. In the drawings:

FIG. 1A is a block diagram of one embodiment of the authorization server system of the present invention.

FIG. 1B is a block diagram of one embodiment of the authorization request system of the present invention.

FIGS. 2A to 2E are schematic depictions of one embodiment of various stages of the method and system of the present invention wherein the customer uses a credit card and a merchant's point-of-sale credit card terminal to make a purchase.

FIGS. 3A to 3C are schematic depictions of one embodiment of various stages of the method and system of the present invention wherein the customer uses a Near Field Communication (NFC)-enabled computing device and a merchant's point-of-sale NFC device to make a purchase.

FIGS. 4A to 4E are schematic depictions of one embodiment of various stages of the method and system of the present invention wherein the customer uses a personal computer to access a dedicated secure transaction application to make a purchase.

FIGS. 5A to 5G are schematic depictions of one embodiment of the system of the present invention wherein the customer uses a personal computer to access a cloud-based dedicated transline shopping browser to make a purchase.

FIG. 6 is a flow chart illustrating a sample process that may be undertaken by the authorization server system in one embodiment of the present invention.

FIGS. 7A and 7B are flow charts illustrating sample processes that may be undertaken by the MDSTA and the bank authorization server system, respectively, in one embodiment of the present invention.

FIGS. 8A and 8B are flow charts illustrating sample processes that may be undertaken by the PC-DSTA and the bank authorization server system, respectively, in one embodiment of the present invention.

FIGS. 9A and 9B are flow charts illustrating sample processes that may be undertaken by the CDSTA and the bank authorization server system, respectively, in one embodiment of the present invention.

### DETAILED DESCRIPTION OF PREFERRED EMBODIMENTS

The present invention relates to a method and a system for secured processing of a credit card payment. Any term or expression not expressly defined herein shall have its commonly accepted definition understood by those skilled in the art, within the context of its use herein.

To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims. References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described or claimed in connection with an embodiment, it is within the knowledge of one skilled in the art to affect or connect such aspect, feature, structure, or characteristic with other embodiments, whether or not explicitly described.

As used herein, the “authorization server system” is a computer device that includes at least one memory component operatively connected to at least one processor, and that is capable of communicating via a network with a customer interface device and a merchant server. The at least one memory component stores a set of instructions that are executable by the at least one processor to implement methods of the present invention. In one embodiment, an authorization server system may include a general purpose computer or server. As an example, the authorization server may be under the control of a financial institution, a credit card issuer, or both of them. In one embodiment, the “network” includes the Internet, a telephone network, or a combination of the foregoing.

As used herein, a “customer” shall refer to a person who uses credit to make a payment. As used herein, a “customer interface device” means a computing device, generally having a processor, used by a customer to transmit information between the computing device and the authorization server via the network. Without limiting the generality of the foregoing, a customer interface device may comprise a point-of-sale credit card terminal, a general purpose computer, or a mobile computing device such as a tablet, smart-phone, or wearable computer.

As used herein, a “merchant” shall refer to a person who ultimately receives payment through the customer's use of credit. As used herein a “merchant server” means a computing device used by a merchant to transmit information between the computing device and the authorization server via network. Without limiting the generality of the foregoing, a merchant server may comprise a point-of-sale credit card terminal, a NFC point-of-sale terminal, or a dedicated server for online retail sales. In one embodiment, the merchant server may be the same the computing device as or be implemented in part by the customer interface device.

As used herein, a “credit transaction” shall refer to any transaction settled using monetary funds or a proxy thereof that are under the custody of a party other than the customer. Non-limiting examples of credit transactions include purchases of goods or services made using a credit card account, a bank debit account, a merchant loyalty program or a merchant gift card program.

As will be appreciated by those of relevant skill, various forms of secure transactions may be processed through the whole or partial use of specialized application programs (“applications”) installed upon or otherwise executable under at least partial control of customer interface devices. For example, electronic payment, and/or other aspects of proposed or consummated transactions, can be implemented using electronic or virtual wallets. Such wallets typically comprise, or otherwise enable access to, secure data sets representing identifiers such as various forms of information associated with specific purchasers. Such a data set may, in some circumstances, alternatively be referred to as a purchaser's profile, and can include or otherwise be associated with a name, telephone number, physical and/or e-mail address, and/or other identification information associated with one or more purchasers, together with application- or process-specific information or identifiers, such as payment information representing one or more different forms or types of payment that the purchaser has been authorized to use. For example, each purchaser account data set may include one or more credit card or account numbers, one or more bank card numbers, one or more gift card numbers, or any other information associated with any type(s) and number(s) of accounts or other payment means associated with a purchaser or group of purchasers. Each such data set may further include, or be associated with, purchaser identification information such as data representing government- or privately-issued IDs such as passports, photos, birth certificates, drivers or citizen identification cards, etc., and/or images thereof.

As will be understood by those skilled in the relevant arts, any communications, payment, and/or other protocols suitable for use in implementing the various aspects of the invention may be used. These include, for example, GSM, EMV-GP (Europay-MasterCard-VISA Global Platform), and other protocols. Global Platform is a platform/organization that has provided standards used to manage applications (e.g., Java Card Applets) on cards. It includes authentication schemes and authorization of additional “security domains”, that may manage applications. EMV is a standard created by Europay, MasterCard and VISA for interoperability of smart cards, including SEs stored on SIM cards, etc., and POS (point of sale) terminals.

The use of appropriately-configured systems in accordance with the disclosure are compatible with, and can provide efficiencies through the adoption of, new technologies, such as improved telecommunications, wireless, and/or near-field technologies and/or protocols. For example, GSM or other wireless telecommunications protocol, Bluetooth, NFC, bar-code, QR (quick-response)-type protocols may be implemented can be used advantageously at any or all points in the system, including for example on either purchaser and/or merchant/vendor side at the point of sale (POS). As a more specific example, which may be advantageously implemented in a wide variety of circumstances, Bluetooth (LE) technologies can be used to communicate with existing Bluetooth enabled POS terminals to process payments that are in accordance with GP EMV and/or other standards.

In one aspect, the present invention provides a method for secured processing of a credit payment that can be implemented by an authorization server. In general, the method involves the following stages.

At the first stage of the method, the authorization server receives from the customer interface device a credit request for a transaction account. The credit request includes a credit amount and a customer security input. At this stage, the transaction account has a zero balance. It will be appreciated that the maintenance of a zero-balance transaction account prevents a person who surreptitiously acquires the transaction account number from making purchases using the transaction account. Therefore, theft of the physical credit card or acquisition of the transaction account numbers is of no value to the thief, unless the thief also acquires information needed to provide the associated customer security input, as discussed below.

At the second stage of the method, the authorization server verifies whether the customer security input is correct before the authorization server debits an offline credit account by the credit amount, and credits the transaction account with the credit amount. As used herein, the term “offline” means that the credit account can be operated upon by only the authorization server system, and cannot be operated on by the customer interface device or the merchant server via the network. In exemplary embodiments, the credit account may be stored on a memory component that is part of the authorization server itself, or accessible through a secured communication network.

A. Character Position

In one embodiment, the customer security input is a digit indicative of the position of a character randomly selected from a transaction account identifier associated with the transaction account and comprising a sequenced string of a plurality of alpha-numeric characters such as a string of digits, letters, symbols, or a combination thereof, that is intelligible as a verse. At least a portion of the transaction account identifier is concealed in the sense that it is known by only the authorization server system and the customer. At the time of the transaction, the authorization server causes the customer interface device to convey a character set that includes one or more of the concealed characters from the transaction account identifier. The one or more concealed characters may be included within a character string, the remaining portions of which may be randomly generated. The authorization server also causes the customer interface device to display a prompt requesting the customer to correctly input a variable (e.g. an alpha-numeric character) indicative of the position(s) of the randomly selected character(s) of the transaction account identifier shown in the character set. Preferably, the authorization server randomly selects the character(s) of the transaction account identifier for display in the character set such that the selected character(s) is different from one transaction to the next. It is preferable that on occasion the character set not include a correct choice and provide the customer with the option of indicating a correct choice is not visible.

In one embodiment, the authorization server system allows the customer only a set number of attempts to successfully provide the variable before requiring the customer provide a different input before allowing the transaction process to proceed. For example, if the customer fails to do so after one attempt, the authorization server system may repeat the foregoing steps using a different concealed character from the transaction account identifier. As another example, if the customer fails to do so after three attempts, the authorization server system may require the customer to enter the concealed portion of the account number in reverse order.

B. PIN Completion

In one embodiment, the method requests an additional or alternative customer security input comprising a character string that comprises a portion of a PIN (personal identification number) associated with the transaction account and comprising a set of alpha-numeric characters (e.g., letters, numbers, punctuation marks, symbols, or a combination thereof), referred to herein as the “PIN set”. As a non-limiting example, the PIN set may be the ordered sequence of characters “6 2 9 7”. The authorization server causes the customer interface device to convey to a character set that includes a character string, e.g. “1 6 3 2 8 3 1 4”. In this string, the characters “6 2” randomly selected from the PIN set are referred to as the “prompt set”. The other characters “1 3 8 3” are generated by the authorization server in accordance with an algorithm, such as a random character generation algorithm. The authorization server also causes the customer interface device to display a prompt requesting the customer to input two additional characters, referred to as the “input set”, for the PIN input. The authorization server determines whether the input set is the relative complement of the prompt set with respect to the PIN set. In this context, the term “relative complement” means the set of characters that completes the PIN set, but is not in the prompt set. In this example, the set of characters “9 7” is the relative complement of the prompt set “6 2” with respect to the PIN set “6 2 9 7”. In one embodiment, the method requires that the prompt set and the input set maintain the order of the characters in the ordered sequence of the PIN set. For example, the prompt set and input set must be “6 2” and “9 7”, respectively, not “2 6” and “7 9”. It will be appreciated that requiring the customer to enter part of the PIN, as opposed to the entire PIN, and combining the PIN set with additional alpha-numeric characters increases the difficulty of surreptitiously acquiring the PIN by visual surveillance, electronic skimming or phishing techniques. Preferably, the authorization server randomly selects the prompt set for display in the character set such that the prompt set is different from one transaction to the next. It is preferable that on occasion the character set not include the prompt set, and the customer is provided with the option of indicating the prompt set is not provided.

In one embodiment, the authorization server allows the customer only a set number of attempts, for example three attempts, to successfully provide the PIN. If the customer fails to do so, the authorization enters into a “safe-mode” status. In the “safe mode”, the customer must input the PIN set in the reverse sequential order. Continuing the example with the PIN set “6 2 9 7”, once the authorization server enters the safe mode, the customer would have to enter the reverse PIN set, being “7 9 2 6”.

C. Payment Amount Verification

In an optional embodiment, the method requests an additional customer security input in the form of a currency value. When the authorization server receives a payment request from the merchant server for a payment amount, the authorization server requests that the customer input or confirm the currency value of the payment amount in order to verify whether the requested payment amount is equal to the previous requested credit amount. If the authorization server is able to make such a verification, then the method proceeds to the third stage. It will be appreciated that verifying that the requested payment account equals the requested payment helps reduce the risk of unauthorized payment requests gaining access to the non-zero credit balance in the transaction account at the end of the second stage. This verification also helps to ensure that the customer having access to the PIN genuinely intended that the credit amount be transferred to the merchant who requested the payment amount.

At the third stage of the method, after all requested or required verifications have been completed, the authorization server debits the transaction account by the credit amount, and credits a merchant account with the credit amount. At the conclusion of the third stage, the credit in the transaction account is returned to a zero-balance, thereby preventing the credit card from being used for a future purpose except in accordance with the foregoing method.

In various aspects and embodiments of the disclosure, secure means for creating, administering, manipulating, processing, and storing of electronic data representing applications such as virtual wallets, PINs, passwords, identifiers and other authorization codes or information, and other information associated with consumer, business, and other payments and/or payment accounts useful in processing payment transactions, and data resulting from or otherwise associated with such processes, can be stored in secure memory remote from devices used by customers to provide payment authorizations. For example, such information may be stored centrally, in a secure environment such as a subsecurity domain (SSD) maintained by a bank or other financial institution (FI) or payment service provider, in the cloud as a secure networked server, or otherwise.

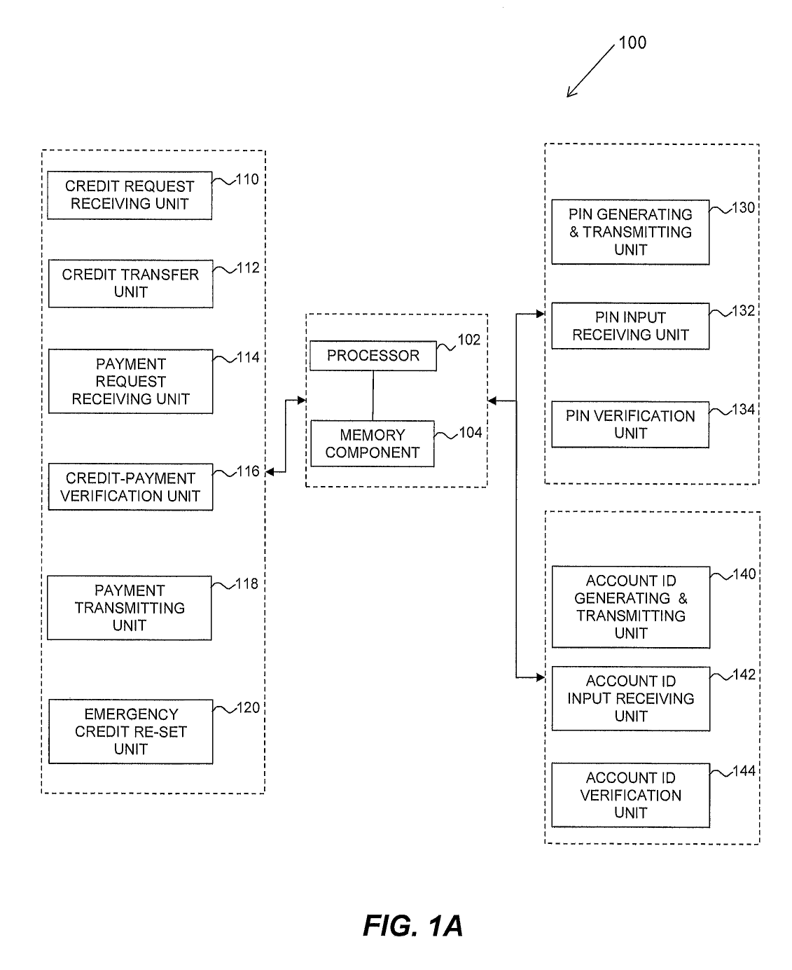

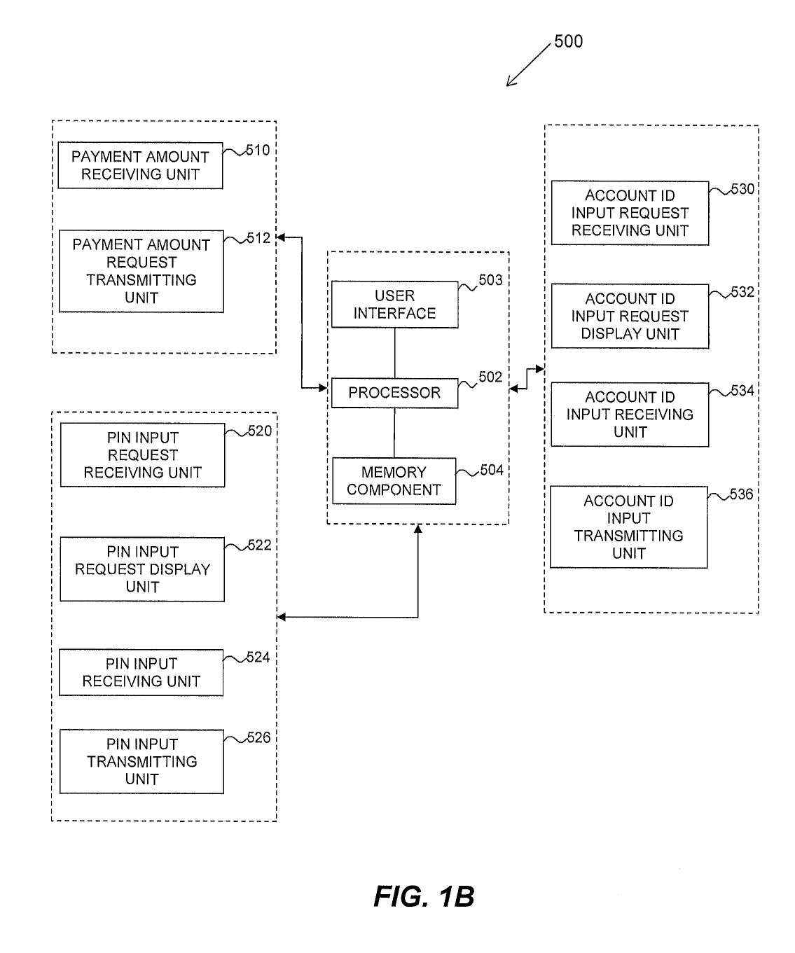

In one aspect, the present invention provides an authorization server system for secured processing of a credit payment in accordance with the method of the present invention. FIG. 1A is a block diagram of one embodiment of such a system (100). The system (100) has a processor (102), a memory component (104), a credit request receiving unit (110), a credit transfer unit (112), a payment request receiving unit (114), a credit-payment verification unit (116), a payment transmitting unit (118), an emergency credit re-set unit (120), a PIN generating and transmitting unit (130), a PIN input receiving unit (132) and a PIN verification unit (134), an account identifier generating unit (140), an account identifier receiving unit (142), and an account identifier verification unit (144).

The processor (102) executes a set of machine-executable instructions stored by the memory component (104). In accordance with the set of instructions, the processor (102) may control the units of the system (100), control the flow of information to, from and between the various units of the system (100), and operate on such information to implement the method of the present invention. It will be understood that the system (100) is capable of communication via a network with a customer interface device and a merchant server.

The credit request receiving unit (110) receives information from the customer interface device describing the requested credit amount. In embodiments, the requested credit amount may reflect the amount that has been debited against an emergency line of credit as stored on a memory component on a credit card.

The credit transfer unit (112) causes an offline credit account to be debited by the requested amount of credit. In embodiments, the credit transfer unit (112) may also cause a transaction account to be credited by the requested amount of credit. The processor (102) may control the credit transfer unit (112) to perform such operations conditional upon verification steps made by the PIN verification unit (134), as described below.

The payment request receiving unit (114) receives a payment request from the merchant server that describes a requested payment amount.

The credit-payment verification unit (116) compares the requested credit amount to the requested payment amount to determine whether or not the two amounts are equal.

The payment transmitting unit (118) causes the transaction account to be debited and a merchant account to be credited with the requested credit amount. The processor (102) may control the payment transmitting unit (118) to perform such operations conditional upon verification steps made by the credit-payment verification unit (116), as described above.

The emergency credit re-set unit (120) causes a writable memory component stored on a credit card and in communication with a customer interface device to be credited with a requested credit amount. The processor (102) may control the emergency credit re-set unit (120) to perform this operation conditional upon verification steps made by the PIN verification unit (134), as described below.

The PIN generating and transmitting unit (130) generates a request for a PIN input and causes it to be transmitted to the customer interface device so that it can be displayed to the customer. In embodiments, the PIN generating and transmitting unit (130) may generate a prompt set including a portion of the PIN set in combination with other alpha-numeric characters generated in accordance with an algorithm such as a random character generation algorithm.

The PIN input receiving unit (132) receives a PIN input from the customer interface device.

The PIN verification unit (134) compares the received PIN input to a PIN associated with the transaction account to determine whether it matches the PIN or a portion thereof. In embodiments, the PIN may be persistently stored by the memory component (104).

The account number generating and transmitting unit (140) generates a request for an account identifier input and causes it to be transmitted to the customer interface device so that it can be displayed to the customer. In embodiments, the account identifier generating and transmitting unit (140) may generate a character set including a selected character of the transaction account identifier.

The account identifier receiving unit (142) receives an input that indicates the digit position of the selected character included in the character set generated and transmitted by the account identifier generating and transmitting unit (140).

The account identifier verification unit (144) compares the digit position received by the account identifier receiving unit (142) with the transaction account identifier to determine whether the digit correctly specifies the position of the selected digit within the transaction account identifier. In embodiments, the transaction account identifier may be persistently stored by the memory component (104).

In another aspect, the present invention provides a memory comprising a recording medium having recorded thereon non-transient instructions, which when executed by a processor of an authorization server system in communication via a network with a customer interface device and a merchant server, causes the authorization server system to carry out the method of the present invention. The recording medium may include any types of recording devices in which instructions that can be read by a processor is stored. The recording medium may be distributed over network-coupled computer systems so that the computer-readable code may be stored and executed in a distributed fashion by the authorization server system and the customer interface device. In one embodiment, the instructions provide an electronic wallet application that handles all communications with and all functions relating to the transaction account and the offline credit account. This allows for separation of the security verification functions of the system and method of the present invention from the communications systems used by the merchant to complete credit transactions. By creating separate layers of communication, the security of information exchanged during the credit transaction is enhanced. In particular, the method and the system of the present information avoid the need to transmit the customer security input, or the transaction account identifier to the merchant server to complete the credit transaction.

In one aspect, the present invention provides an authorization requesting system, such as a merchant credit card terminal or other point-of-sale device, or a computing device directly or remotely operated by the customer, for requesting payment authorization and receiving and transmitting user input for the processing of a credit payment in accordance with the method of the present invention. FIG. 1B is a block diagram of one embodiment of such a system (500). The system (500) has a processor (502), a user interface (503), a memory component (504), a payment amount receiving unit (510), a payment amount request transmitting unit (512), a PIN input request receiving unit (520), a PIN input request display unit (522), a PIN input receiving unit (524), a PIN input transmitting unit (526), an account identifier input request receiving unit (530), an account identifier input request display unit (532) and an account identifier input receiving unit (534), an account identifier input transmitting unit (536).

The processor (502) executes a set of non-transient instructions stored by the memory component (504). In accordance with the set of instructions, the processor (502) may control the units of the system (500), control the flow of information to, from and between the various units of the system (500), and operate on such information to implement the method of the present invention. It will be understood that the system (500) is capable of communication via a network with an authorization server system and a merchant server.

The user interface (503) allows information to be displayed to the customer and to be inputted by the customer. For example, the user interface may comprise one or more of: a display screen, touch screen, keyboard, keypad, mouse, light pen, stylus, etc.

The payment amount receiving unit (510) receives information from the merchant, for example from a point-of-sale cash register, a requested payment amount.

The payment amount request transmitting unit (512) transmits a payment request describing the requested payment amount to the authorization server system.

The PIN input request receiving unit (520) receives a PIN input request, having a character set and a customer security input prompt, from the authorization server system. The PIN input request display unit (522) causes the user interface (503) to display the character set and the customer security input prompt. The memory component (504) may store the PIN input request, but preferably only temporarily (e.g. only for the duration of the credit transaction).

The PIN input receiving unit (524) receives a customer security input submitted by the customer via the user interface. The memory component (504) may store the customer security input, but preferably only temporarily. The PIN input transmitting unit (526) transmits the customer security input to the authorization server system.

The account identifier input request receiving unit (530) receives an account identifier input request, having a character set and a customer security input prompt, from the authorization server system. The account identifier input request display unit (532) causes the user interface (503) to display the character set and the customer security input prompt. The memory component (504) may store the account identifier input request, but preferably only temporarily.

The account identifier input receiving unit (534) receives a customer security input submitted by the customer, indicating the digit position of the selected character included in the character set, via the user interface. The memory component (504) may store the customer security input, but preferably only temporarily. The account identifier transmitting unit (536) transmits the customer security input to the authorization server system. The account identifier transmitting unit (536) may cause the customer security input to be transmitted within a string of randomly generated alpha-numeric characters to further increase the difficulty of determining the concealed portion of the transaction account number by a third party.

In another aspect, the present invention provides a memory comprising a recording medium having recorded thereon instructions, which when executed by a processor of authorization requesting system in communication via a network with a bank authorization server and a merchant server, causes the authorization requesting system to carry out the method of the present invention. The recording medium may include any types of recording devices in which instructions that can be read by a processor is stored. The recording medium may be distributed over network-coupled computer systems so that the computer-readable code may be stored and executed in a distributed fashion by the authorization server system and the customer interface device.

### EXAMPLES

The method as generally described above, is now further described in reference to the following non-limiting examples. It will be understood that all of the following payment processing examples may be implemented using a single credit card having, or any customer device associated with, the same multi-character transaction account number. It will be understood that the above-described customer security input methods may be implemented individually or in combination with one another within the present invention.

### Example 1: Card-in-Hand Payment Transaction

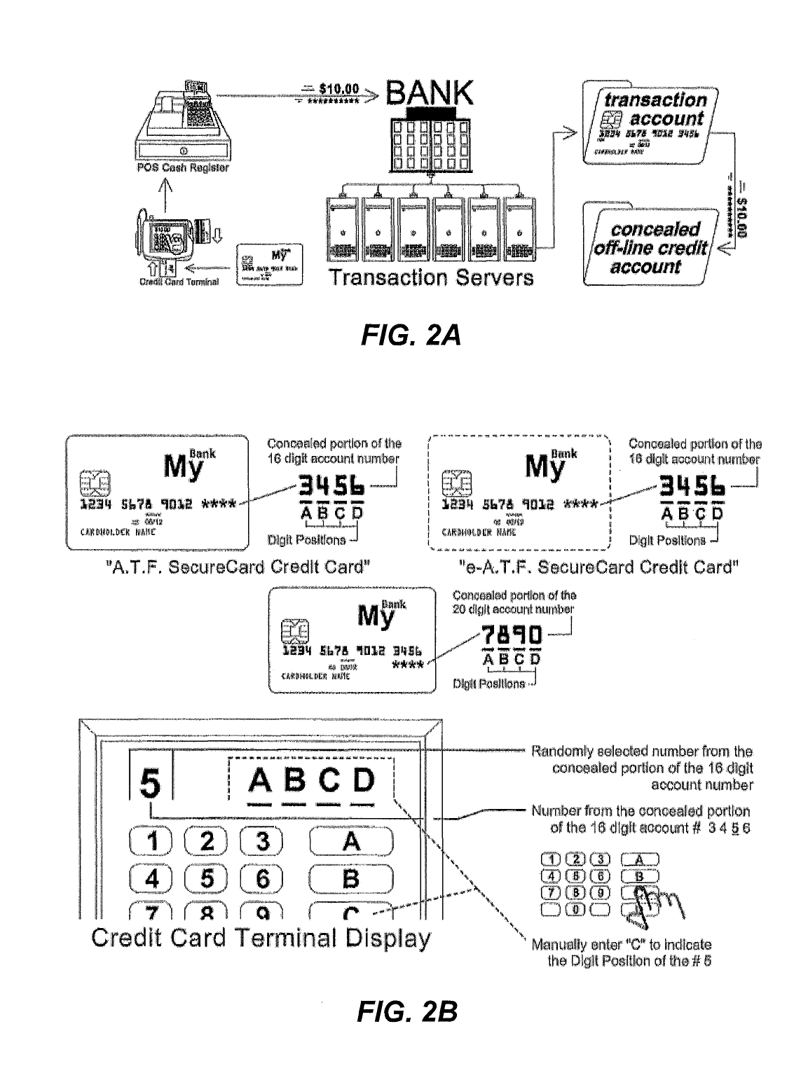

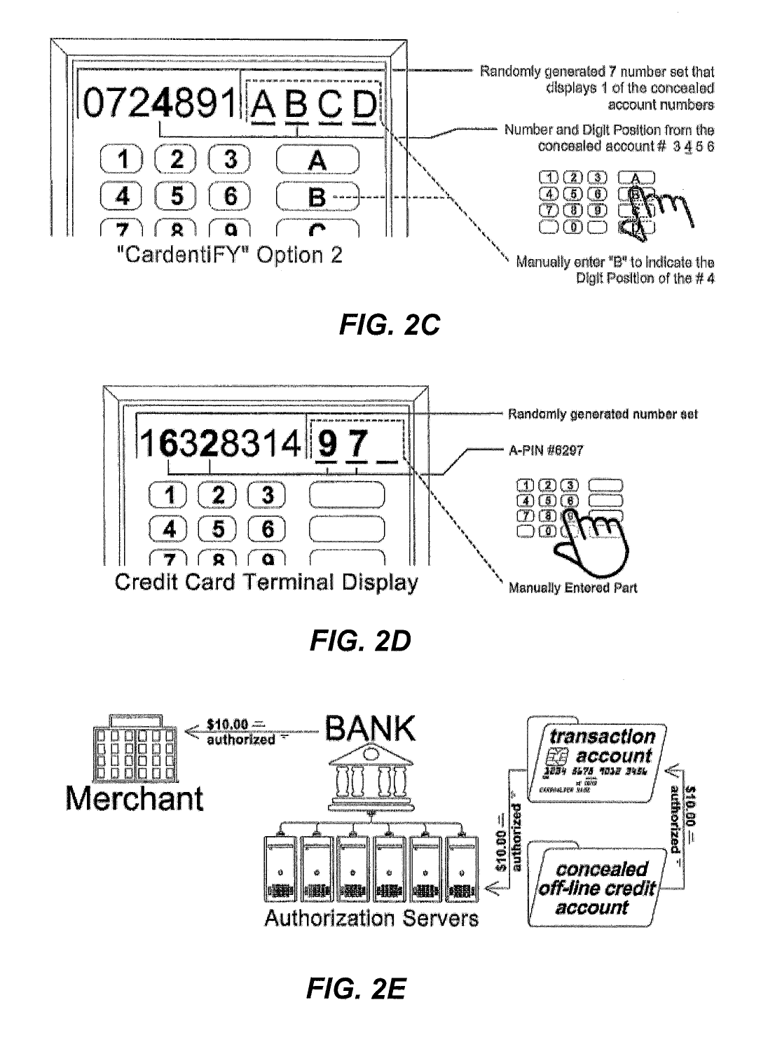

This example is schematically depicted in FIGS. 2A to 2E, and relates to the use of the authorization server system to process a payment made by the customer using a point-of-sale credit card terminal, which serves as both the customer interface device and as the merchant server.

Referring to FIG. 2A, the merchant's point-of-sale (“POS”) cash register 202 calculates a total payment amount. The total payment amount is transferred to merchant's credit card terminal 204. To begin the transaction, the customer provides the credit card information (e.g., multi-character credit card account number, and cardholder name) using the credit card terminal by swiping the magnetic stripe of the credit card 206 into a magnetic stripe card reader, inserting the electronic chip of the credit card into a chip reader, placing the electronic chip near a contactless card reader, or manually keying in information into a keypad of the credit card terminal. Next, the customer is prompted to verify and agree to the requested credit amount, which is equal to the payment amount requested by the merchant.

The confirmed payment amount along with the customer's credit card details (e.g., the multi-character credit transaction account number) are transmitted from the merchant's POS system to a bank's authorization server system 208. The bank's secure authorization server system receives the customers' credit card details and the requested credit amount. This activates a request from the customer's transaction account 210 to the concealed offline credit account 212. If the balance in the credit account is sufficient to cover the payment amount, the credit amount is readied for transfer from the concealed offline credit account to the transaction account.

Referring to FIG. 2B, in this example, the account number 214 associated with the credit card is “1234 5678 9012 3456” and constitutes the transaction account identifier. The terminal four digits 216 of the account number “3456” are known by only the authorization server account and the customer. Unlike a conventional credit card, the terminal four digits “3456” of the account number are not shown on the credit card itself, encoded in a magnetic strip on the card, or encoded in the electronic chip on the card. This makes it impossible for the merchant or a thief to determine the account number by physical or electronic inspection of the credit card.

The authorization server causes the credit card terminal 204 to display a character set 217 comprising one or more characters, wherein at least one of the characters is randomly selected from the characters of the concealed portion of the transaction account. In this example, the credit card terminal displays the digit “5” from the concealed portion “3456” of the transaction account number, and a prompt 218 to the customer to input the digit position of the randomly selected digit. In this example, the customer must draw upon his or her memory to input the character “C” to indicate that the selected digit “5” corresponds to the digit position “C” of the concealed portion of the account number. The character “C” may be input and transmitted within a string of other randomly generated alpha-numeric characters to further increase the difficulty of determining the concealed portion of the transaction account number.

In one embodiment, the character set 217 may be a string of randomly selected characters having embedded therein a character randomly selected from the concealed portion of the transaction account number within. In the example shown in FIG. 2C, the authorization server causes the credit card terminal 204 to display the digit “4” randomly selected from the concealed portion “3456” of the transaction account number, and a prompt 218 to the customer to input the digit position of the randomly selected digit. The digit “4” is embedded in a random position within the character string “0724891”, with the other digits “072891” being randomly generated. In this example, the customer must draw upon his or her memory to input the character “B” to indicate that the selected digit “4” corresponds to the digit position “B” of the concealed portion of the account number. In order for the transaction to proceed, the authorization server system must verify that the customer has input the correct digit position.

Conventional credit cards that display their sixteen digit account numbers may be readily adapted for use with this verification method by associating them with an additional string of digits. For example, in FIG. 2B, a conventional credit card 206′ that displays all 16 digits of its account number 214′ can be assigned in the authorization server an additional four digits 216′ which are not displayed on the card and known to only the authorization server account and the customer.

Alternatively or additionally, the authorization server system may require a different customer security input to verify the account. Referring to FIG. 2D, the PIN in this example is “6 2 9 7”. The credit card terminal 204 displays a character set 317 with one or more characters. The character set has one or more characters randomly selected from the PIN embedded therein. In this example, the character set 317 contains eight random numbers “6 3 2 8 3 1 4” having part of the PIN “6 2” and the terminal 204 displays a prompt 318 to the customer to manually enter the missing numbers to complete the PIN. The missing numbers may be required to be entered sequentially as they appear in the PIN, such that the combination of the numbers identified as being part of the PIN amongst the eight random displayed numbers and the entered numbers complement each other to form the PIN in the correct sequence. In this example, the customer enters the digits “9” and “7” sequentially. The displayed PIN numbers may change position amongst the character set 317 for every transaction, but preferably remain in their sequential order. For greater security, the method can be configured to support larger PINs having more than 4 digits, or to incorporate alphabetic letters, punctuation marks or other symbols.

Referring to FIG. 2E, once the customer security input has been verified, the requested credit amount is released from the concealed offline credit account 212 to the transaction account 210 for disbursement to the merchant M to conclude the purchase transaction. The amount transferred to the transaction account, and then to the merchant, is equivalent the total purchase price. The available line of credit in the transaction account returns to zero.

In one embodiment, the method permits the customer to use an emergency line of credit stored on the card. This provides a failsafe payment process (FPP) allowing the credit card payment to be processed even if network communication between the authorization server and the customer interface device is unavailable due to technical difficulties. As an example, the amount of the emergency line of credit depends on the credit worthiness of the individual customer. When the emergency line of credit is used, the credit card persistently stores a FPP usage marker and the amount of credit used from the emergency line of credit. When the customer next attempts to use the credit card, this information is transmitted to the bank's authorization server system. The authorization server system causes the amount of credit used from the emergency line of credit to be debited against the credit account, and credited to the emergency line of credit and thereby replenish it for future use. This emergency line of credit refill process must be completed before any further purchase transactions can be authenticated. This prevents the customer from exceeding an authorized offline credit. In addition, the authorization server system will verify that the sum of all current outstanding transactions amounts is to equal the total combined amount of the credit in the offline credit account and the failsafe emergency line of credit stored on the card.

While in this example the authorization server requests an account identifier input first and then a PIN input, it will be understood that the reverse order is also possible.

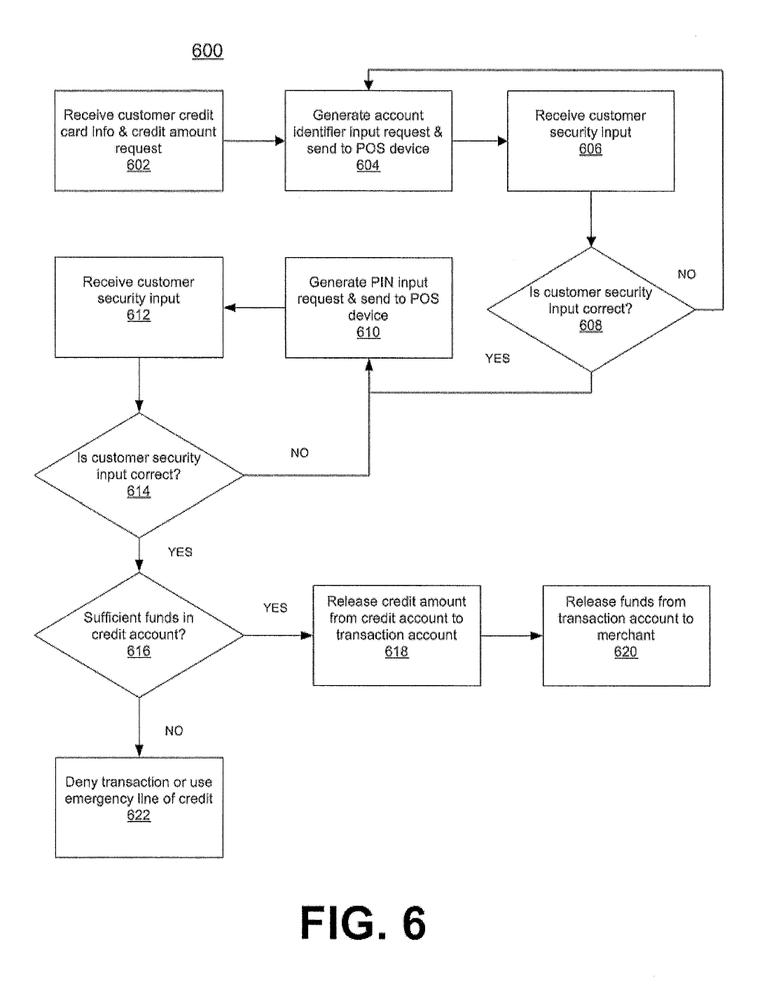

With reference to FIG. 6, a process flow chart illustrates a sample process 600 that may be undertaken by the authorization server system with respect to this Example 1. The authorization server first receives customer credit card information and a credit amount request from the POS device (602). The server then generates an account identifier input request, consisting of a character set and a prompt, and transmits the request to the POS device (604).

The server receives the customer security input with respect to the account identifier input request (606) and then checks whether the customer security input is correct (608). If the customer security input is not correct, the system generates another account identifier input request, which may or may not be the same as the previous request, and transmits the request to the POS device (604). If the customer security input is correct, the system then generates a PIN input request, consisting of a character set and a prompt, and transmits the request to the POS device (610).

The system then receives a second customer security input with respect to the PIN input request (612) and checks whether the second customer security input is correct (614). If the second customer security input is not correct, the system generates another PIN input request, which may or may not be the same as the previous PIN input request, and transmit the request to the POS device.

If the second customer security input is correct, the system checks whether there are sufficient funds in the credit account to fulfill the requested credit amount (616). If there are sufficient funds, the system releases the requested credit amount from the credit account to the transaction account (618), and the funds from the transaction account are then disbursed to the merchant (620). If the credit account does not have sufficient funds or there is a network connection error, the system may deny the transaction or use the emergency line of credit, if available (622).

### Example 2: NFC-Enabled Mobile Computing Device Payment Transaction

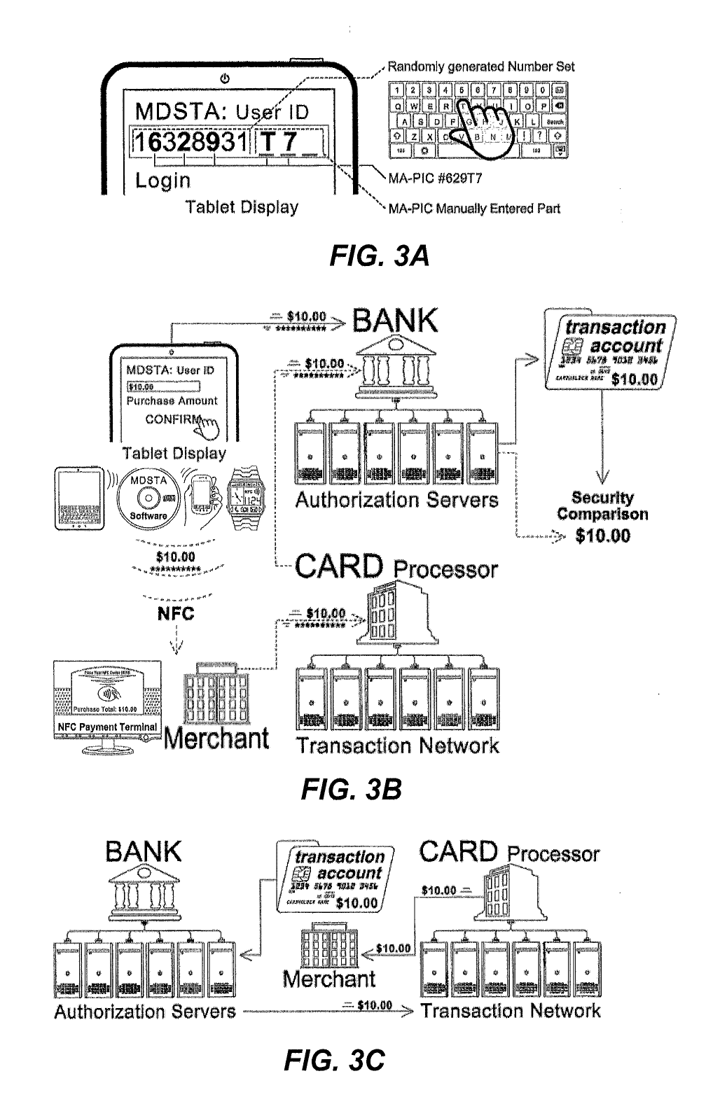

This example is schematically depicted in FIGS. 3A to 3C and relates to the use of the authorization server system to process a payment made by a customer using a mobile computing device connected to the internet that communicates using near-field communication (NFC) technology with a merchant's NFC payment terminal. By way of non-limiting examples, the mobile computing device may be a tablet computer, a smart phone, a wearable smart watch, etc.

The mobile computing device has a processor and a memory component which stores a set of instructions (hereinafter referred to as the “Mobile Dedicated Secure Transaction Application” (MDSTA)). The set of instruction may be executed by the processor to implement the following functionality:
(a) storing digital/electronic versions of the customer's credit card (E-credit card), gift cards, loyalty cards, government issued identification information and the like for NFC use;
(b) storing merchant-specific shopping templates which contain all the information needed to fill in the required fields for a shopping cart for a specific merchant, to facilitate multiple transactions with that specific merchant;
(c) storing a master database of the personal details needed to complete an online transaction and build a merchant shopping template, including without limitation, the customer name, address, shipping preference and credit card information;
(d) establishing secured communication with the bank's authorization server system via a network (e.g., a cellular phone internet, WiFi internet or a combination thereof);
(e) separating the secure transaction communication with the bank's secure authorization network between the card processor transaction network and the MDSTA, which enhances security of the payment process by not conducting all the communication over the same single line; and
(f) implementing a failsafe payment process (FPP) as described above, which allows a customer to access a stored-on-chip emergency line of credit, when the credit card senses that the authentication network is unavailable due to technical difficulties.

Referring to FIG. 3A, the customer selects a mobile device, in this example a tablet computer, to use as the customer interface device 402 and logs onto the MDSTA by entering a PIN or a portion thereof. The MDSTA user interface 415 requires the customer to enter his or her user ID and the missing numbers/letters needed to complete his or her PIN set, “6 2 9 T 7”. The user interface 415 displays on the mobile device display a character set of one or more characters 417 containing at least one of the characters in the customer's PIN set. In this example, the character set 417 has eight random numbers/letters “1 6 3 2 8 9 3 1” that contain part of the customer's PIN set. The customer is requested in a prompt 418 to enter the remaining characters of the PIN that are not shown in the character set 417. In this example, the customer enters the number and letter “T 7” sequentially as they appear in the PIN set to complete the PIN set.

Once the customer has logged into the MDSTA, the MDSTA establishes communication with the bank's authorization server system 208 and the associated transaction account 210, and then enters a standby mode and waits for a requested credit amount to be keyed in for approval. When the customer wishes to make a purchase, the customer enters the requested credit amount using the MDSTA interface 415 and confirms the purchase. The confirmation is transmitted to the authorization server system and triggers a request to transfer an amount of credit from the credit account to the transaction account.

In order to complete the purchase, the customer brings the mobile device 402 with the required near-field distance of the NFC payment terminal 404 of the merchant M, thereby causing the mobile device to transmit the customer details (e.g., the transaction account number and the payment amount) to the NFC payment terminal 404. As soon as the NFC payment terminal confirms that it has received all the details from the mobile device needed to complete the transaction, the MDSTA automatically signs out the customer, thereby preventing NFC bleed and limiting access time to any hackers. The requested payment amount and the customer details are transmitted by the NFC payment terminal to the bank's authorization server system via the card processor transaction network 409. The authorization server system 208 transfers the credit amount from the credit account to the transaction account 210. The authorization server system then compares the keyed-in credit amount previously transmitted from the MDSTA to the payment amount transmitted by the merchant's NFC payment terminal 404 via the card processor transaction network 409.

Referring to FIG. 3C, with all security measures verified, the authorization server system 208 releases the credit amount from the transaction account 210 for disbursement to the merchant account to conclude the purchase transaction. The amount transferred to the transaction account, and then to the merchant, is equivalent the total purchase price. Upon the completion of the transaction, the balance of available credit in the transaction account returns to zero.

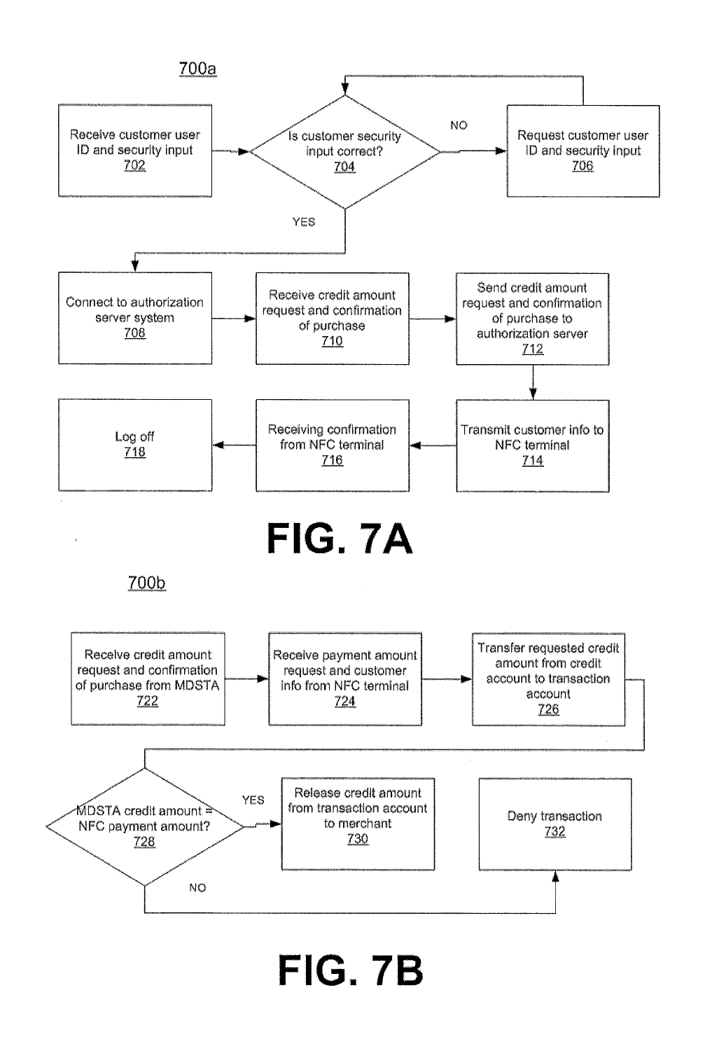

FIGS. 7A and 7B illustrate sample processes 700a and 700b that may be undertaken by the MDSTA and the bank authorization server system, respectively, with respect to this Example 2. First, the MDSTA receives the customer's login information which includes a user ID and a customer security input (702). The customer security input is in response to, for example, a PIN input request which consists of a character set and a prompt. The MDSTA then verifies the ID and customer security input.

If the user ID and customer security input are not correct, the MDSTA re-request this information (706). If the user ID and customer security input are correct, the MDSTA connects to the bank's authorization server system (708). Once the MDSTA receives a credit amount request and confirmation of purchase from the customer (710), the MDSTA forwards same to the authorization server (712). The authorization server receives the credit amount request and confirmation from the MDSTA (722).

When the customer interface device is placed near the NFC terminal, the MDSTA transmits the customer's information (e.g., the transaction account number and the payment amount) to the NFC terminal (714). Once the MDSTA receives a confirmation from the NFC terminal (716) of the receipt of the customer's information, the MDSTA logs off the customer (718).

The authorization server receives a payment amount request and customer information from the NFC terminal via the card processor transaction network (724). The server than transfer the requested credit amount from the credit account to the transaction account (726). The server checks whether the value of the requested credit amount is the same as that of the requested payment amount (728). If the values are the same, the server releases the credit amount from the transaction account to the merchant (730). If the values are different, the server denies the transaction (732).

### Example 3: Standard Online Personal Computer (PC) Transaction

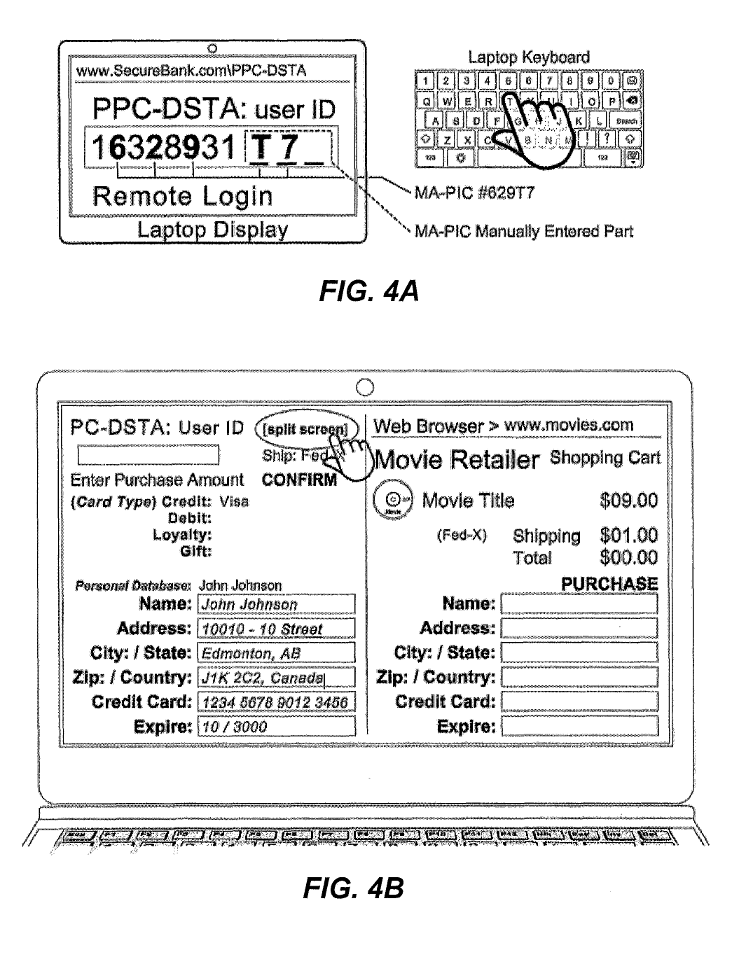

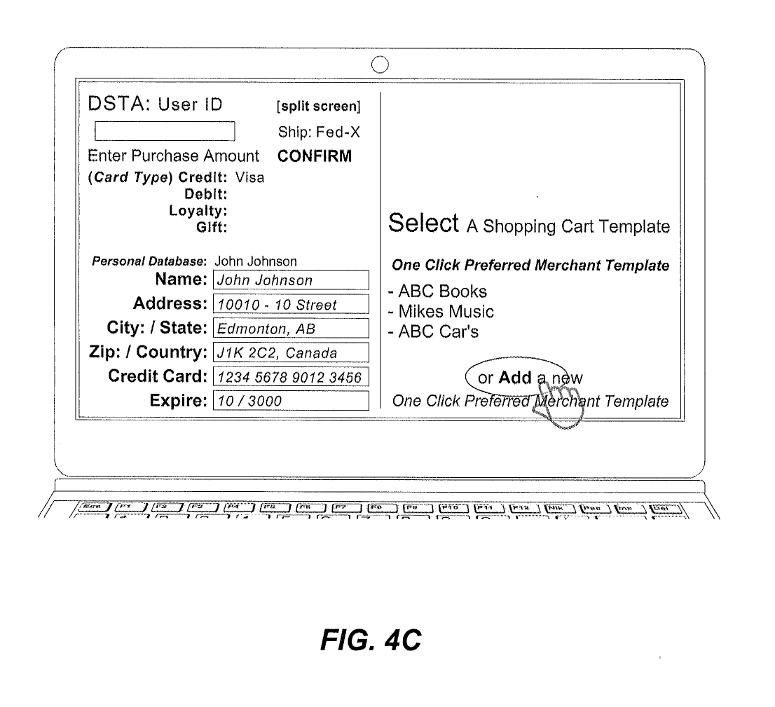

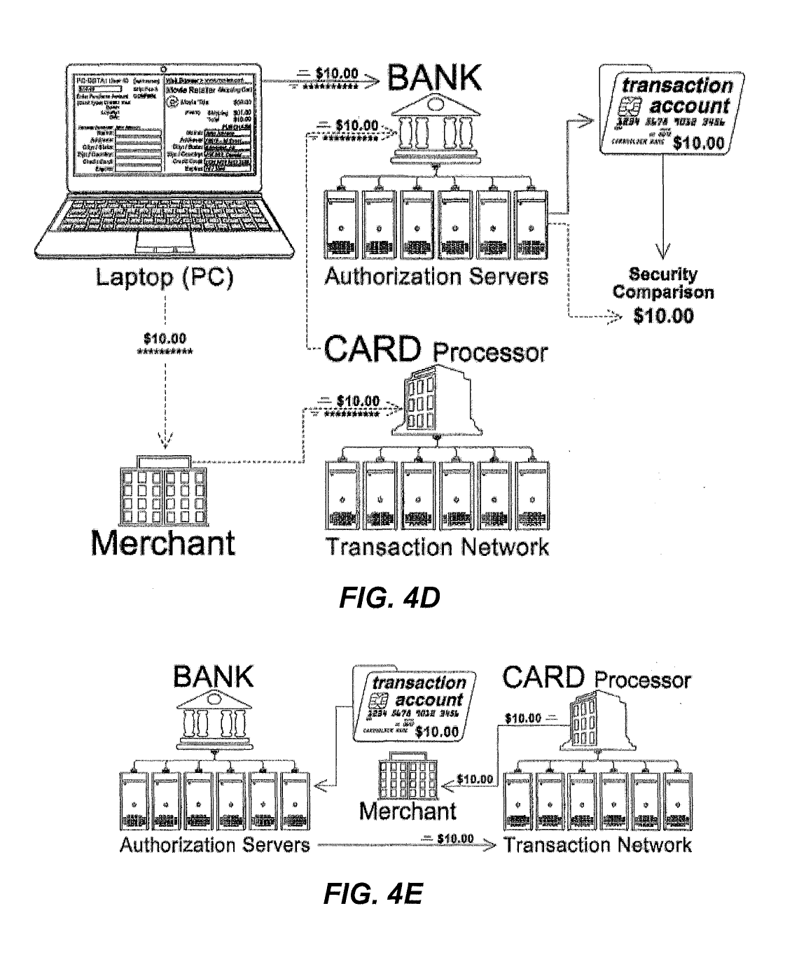

This example is schematically depicted in FIGS. 4A to 4D and relates to the use of the authorization server system to process a payment made by a customer using a computing device, such as a personal computer, connected to the Internet.

The bank's authorization server system has a processor and a memory component which stores a set of instructions (hereinafter referred to as the “PC Dedicated Secure Transaction Application” (PC-DSTA)). The set of instructions may be executed by the processor to implement the following functionality:
(a) storing digital/electronic versions of the customer's credit card (E-credit card), gift cards, loyalty cards, government issued identification information and the like for NFC use;
(b) storing merchant-specific shopping templates which contain all the information needed to fill in the required fields for a shopping cart for a specific merchant, to facilitate multiple transactions with that specific merchant;
(c) storing a master database of the personal details needed to complete an online transaction and build a merchant shopping template, including without limitation, the customer name, address, shipping preference and credit card information; and
(d) establishing secured communication with the customer's computing device via a network (e.g., a cellular phone internet, WiFi internet or a combination thereof).

Referring to FIG. 4A, the customer uses a web-browser on a personal computer 502 to access a user interface 515 for the PC-DSTA hosted by the bank's authorization server system 508. The customer uses the personal computer to log into the PC-DSTA by entering a PIN or a portion thereof, in a manner substantially the same as the manner described in Example 2 when the customer logs into the MDSTA. Once the customer has logged into the PC-DSTA, a connection established to the transaction account. The PC-DSTA is now in standby mode and waits for a credit amount to be keyed in for approval.

Referring to FIG. 4B, the customer may then begin online shopping by opening a web-browser session 516 to the webpage of an online merchant. After adding all the goods or services to the merchant's online shopping cart, the online transaction is ready to be finalized. The customer returns to the webpage directed to the PC-DSTA and activates the forced side-by-side split screen function which embeds the interface 515 for the DSTA into one side of the screen and the web browser 516 into the right side of the PC-DSTA. The PC-DSTA is pre-populated with the personal information of the customer such as the customer's name, address, shipping preference, and credit card information. This information can be directly transferred or assigned from the PC-DSTA interface to the merchant's shopping cart in the web browser using a variety of different processes such as a “drag and drop” gesture, a “cut and paste” method, or a one-click technique for a preferred merchant template, described below. Entering all the personal details required to complete the shopping cart form produces the “Total” payment amount on the merchant's shopping cart check-out. The customer enters the requested credit amount into the PC-DSTA interface and clicks the “Confirm” button on the PC-DSTA interface.

Referring to FIG. 4D, this activates a request from the transaction account 210 to the concealed offline credit account and based on the amount of credit available, the requested credit amount is transferred to the transaction account and readied for disbursement to the merchant M. As soon as the credit amount transfer to the transaction account is verified, that triggers a command to automatically log the customer off the PC-DSTA.

Referring back to FIG. 4B, the customer then clicks on the “Purchase” button of the merchant's shopping cart checkout.

Referring back to FIG. 4D, the merchant's requested payment amount and the customer's details are transmitted to the bank's authorization server 208 via the card processor transaction network 409. With the customer's transaction account credited with the credit amount, the banks authorization server system compares the keyed-in credit amount previously requested by the customer using the PC-DSTA interface to the payment amount submitted from the merchant via the card processor transaction network.

Referring to FIG. 4E, with all security measures verified, the bank's authorization server system 208 then releases the credit amount to the card processor transaction network 409 for disbursement to the merchant's bank. Upon the completion of the transaction, the balance of available credit in the transaction account 210 returns to zero.

The PC-DSTA can also by synchronized with software providing remote access from a bank's virtual private network (VPN). This enables the customer to access the features and data of the PC-DSTA remotely, to make purchases using public personal computers, such as provided in hotels, internet cafes and libraries, without compromising security.

In one embodiment, with reference to FIG. 4C, every time a customer makes a purchase from a new merchant, the merchants shopping cart transfer process, described above, may be stored as a preferred merchant template for future use and the template may be accessed by the customer with one click via a shortcut 550 shown in the PC-DSTA interface 515. The system 208 may optionally provide merchants with a downloadable version of the template for their frequent customers.

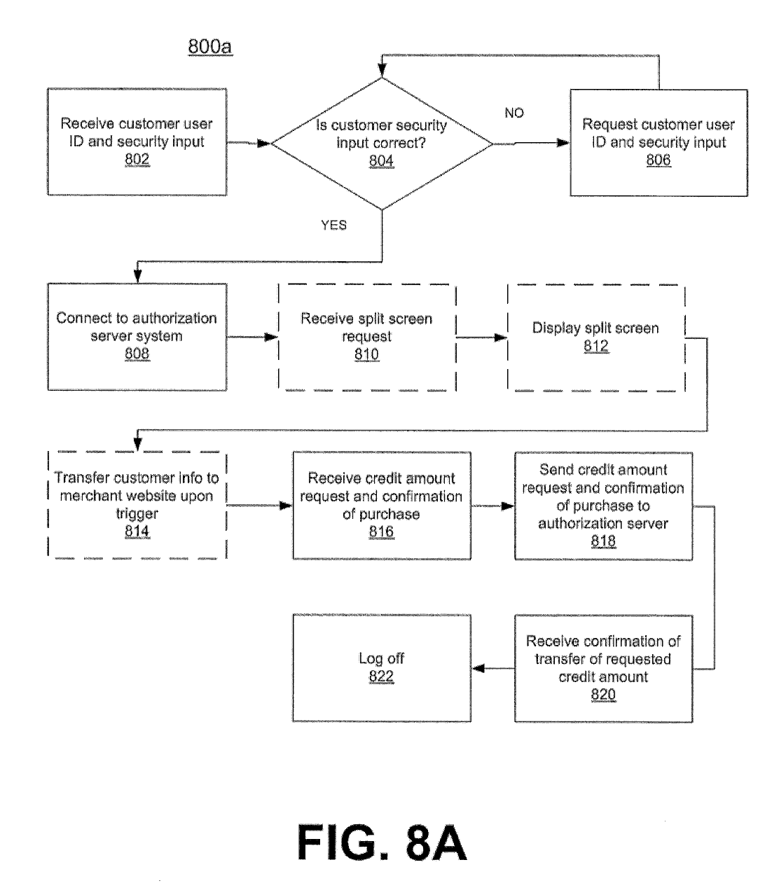

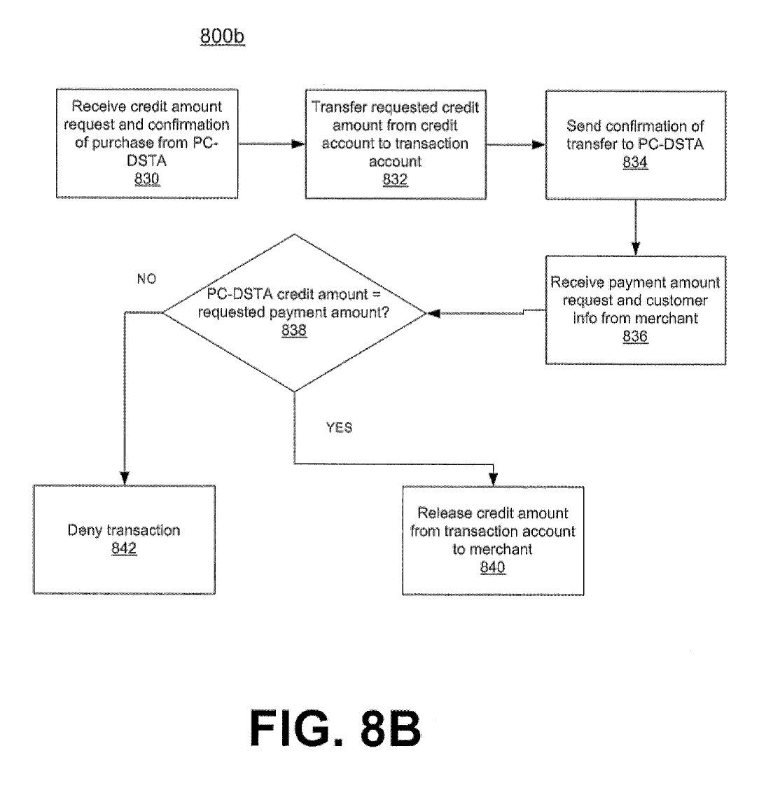

FIGS. 8A and 8B illustrate sample processes 800a and 800b that may be undertaken by the PC-DSTA and the bank authorization server system, respectively, with respect to this Example 3. First, the PC-DSTA receives the customer's login information which includes a user ID and a customer security input (802). The customer security input is in response to, for example, a PIN input request which consists of a character set and a prompt. The PC-DSTA then verifies the ID and customer security input (804).

If the user ID and customer security input are not correct, the PC-DSTA re-request this information (806). If the user ID and customer security input are correct, the PC-DSTA connects to the bank's authorization server system (808). If the PC-DSTA receives a split-screen request (810), the PC-DSTA displays a split screen with the PC-DSTA interface on once side and the merchant website on the other side (812). If the PC-DSTA receives a trigger (e.g. drag and drop, cut and paste, one-click, etc.) to copy the customer information to the merchant website, the PC-DSTA populates the merchant website with the information (814). Once the PC-DSTA receives a credit amount request and confirmation of purchase from the customer (816), the PC-DSTA forwards same to the authorization server (818).

Upon receipt of the credit amount request and confirmation from the PC-DSTA (830), the authorization server transfers the requested credit amount from the credit account to the transaction account (832) and sends a confirmation to the PC-DSTA (834). Once the PC-DSTA receives a confirmation from the authorization server of the transfer (820), the PC-DSTA logs off the customer (822).

The authorization server receives a payment amount request and customer information from the merchant via the card processor transaction network (836). The authorization server checks whether the value of the requested credit amount is the same as that of the requested payment amount (838). If the values are the same, the authorization server releases the credit amount from the transaction account to the merchant via the card processor transaction network (840). If the values are different, the server denies the transaction (842).

### Example 4: Cloud-Based Transline Shopping Browser

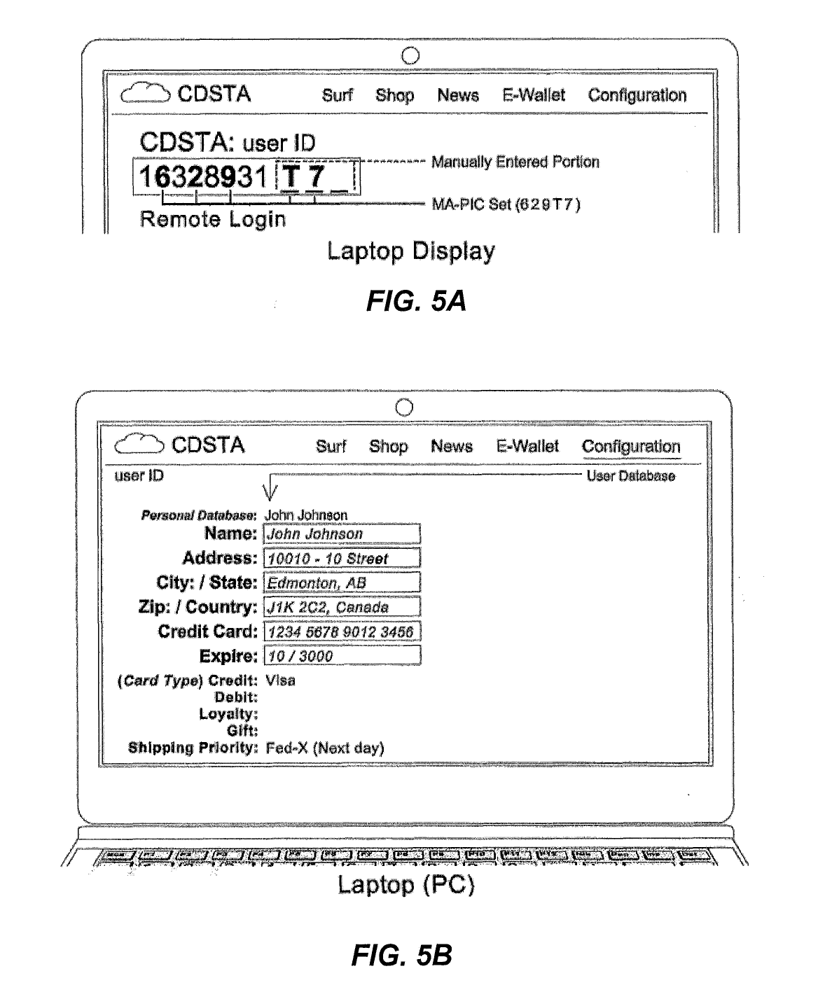

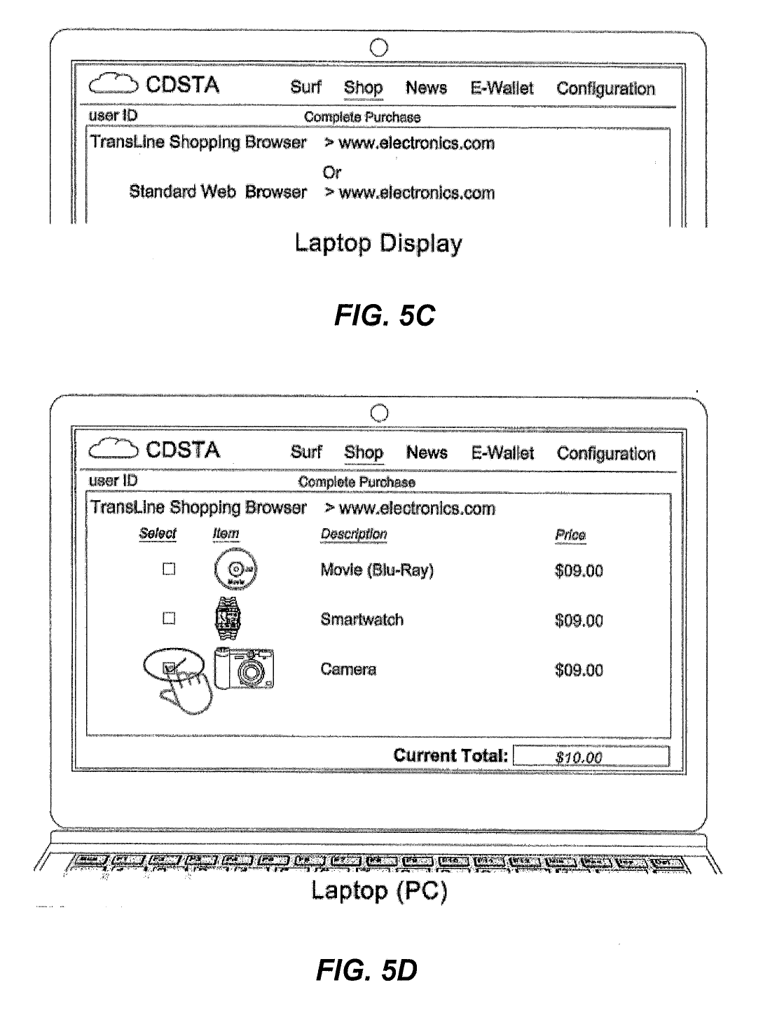

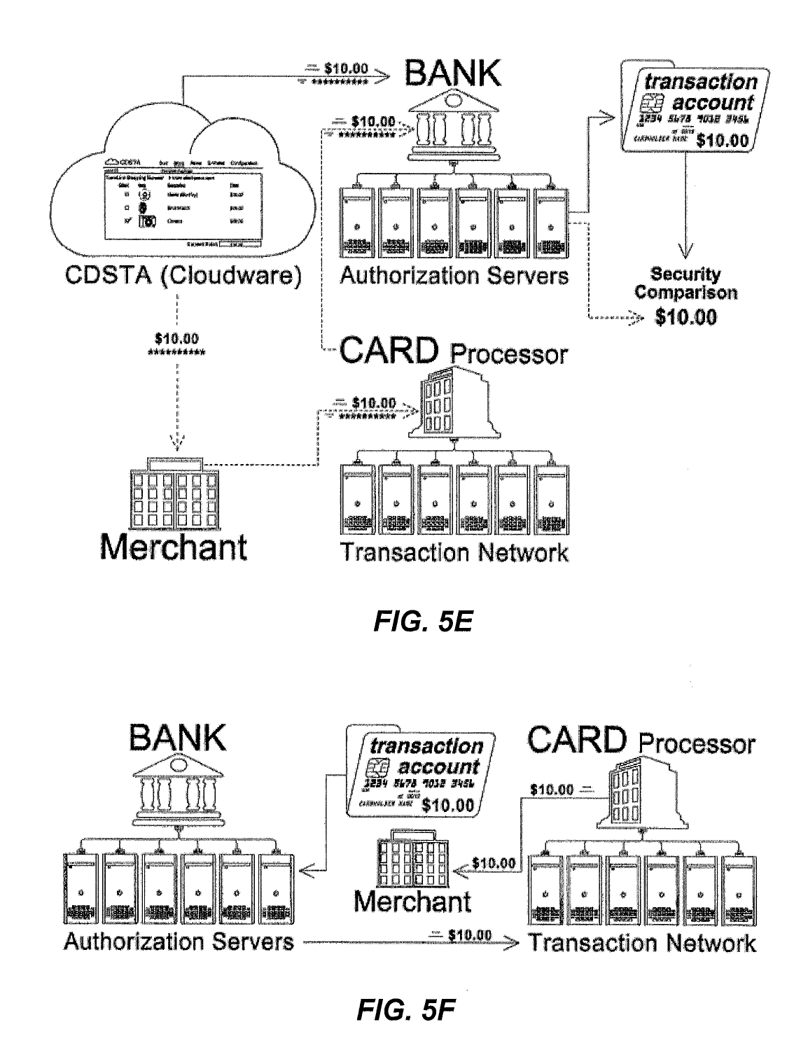

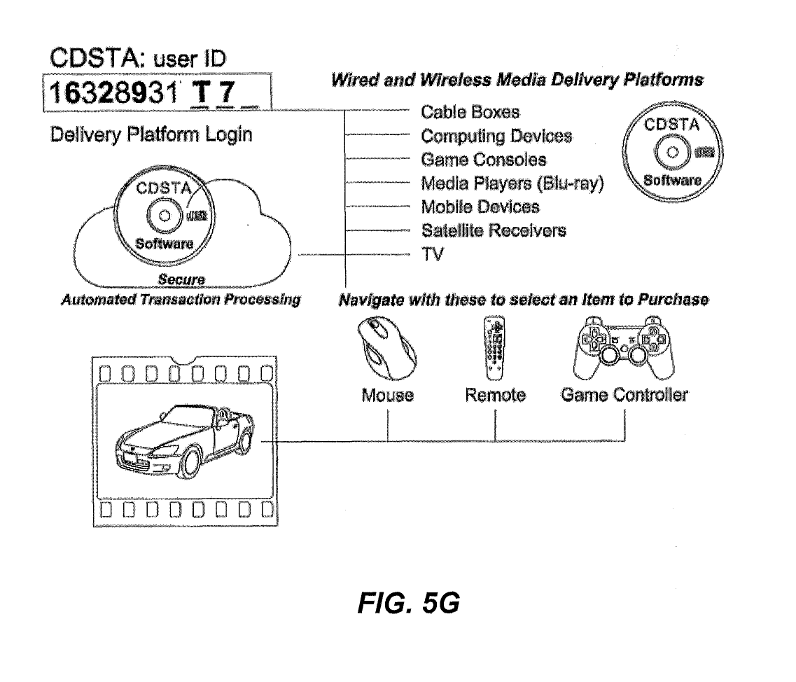

This example is schematically depicted in FIGS. 5A to 5G and relates to the use of the authorization server system to process a payment made by a customer using a computing device accessing a cloud-based transline shopping browser (TSB).

This example of a TSB transaction differs from the standard online transaction system in several key respects. First, the TSB is a cloud-based shopping browser application. Second, the TSB has a number of shopping-specific developments geared exclusively towards online transactions. As traditional web surfing is needed to lead to online purchases, the new cloud based shopping browser may include a full HTML 5 specification and more, allowing it to function at the same level as any current browser. The use of this new type of browser eliminates multiple steps to complete a purchase while providing the most secure transaction of any type.

A new Cloud Dedicated Secure Transaction Application (CDSTA) can be run together with a traditional browser or utilizing its own TSB. Rather than begin loaded onto a customer interface device, the CDSTA is a cloud-based hybrid electronic wallet and browser system that stores all the details relevant to purchase transactions in a remote computer (the cloud) for automated purchasing, and transaction account and offline credit account management.

Either of the two described systems can conduct the entire payment transaction with zero involvement from the customer and is concluded while the account owner is no longer logged into the service. Aside from the one-time configuration of the customer's personal account information, and an appropriate login, verification or authentication step, the only requirement to complete an online purchase transaction is the selection of the items to be purchased. The initial configuration requires shipping details and TSB credit card data. Additional support is incorporated to allow for debit, loyalty and gift cards as well.

Referring to FIG. 5A, the customer uses a computing device 602, such as a personal computer, to access a user interface 615 for the cloud-based CDSTA. The customer uses the personal computer to log into the CDSTA by entering a PIN or a portion thereof, in a manner substantially the same as the manner describe in Example 2 when the customer logs into the MDSTA.

Referring to FIG. 5B, the CDSTA requires an initial one-time configuration process to be completed wherein the customer uses the personal computer to enter personal information relating to the credit card and shopping and shipping preferences.

Referring to FIG. 5C, the CDSTA provides the customer with the choice of using any current browser as the preferred embedded shopping browser or the CDSTA's own TSB. In the case of the former, the embedded browser functions as any normal browser, but runs as a remote cloud application and not from the local computing device that the customer has logged in on.

Referring to FIG. 5D, the customer selects in the interface 615 items he or she would like to purchase to add them to the online shopping cart. The purchase transaction itself requires no direct input from the customer other than the customer selecting the items to be purchased to complete the transaction. The transaction is completed by a transaction-bot that implements an automated transaction process. If the merchant is set up to allow purchases using the CDSTA standards (i.e., CDSTA compliant), then the CDSTA can retrieve the customer's preferred shipping method from the information cloud-based storage and calculate a running total that includes any relative taxes and shipping charges. This running total is continuously adjusted and displayed in the “Current Total” field. The CDSTA software generates and submits a retail purchase order (Retail-PO) to the merchant along with all the necessary details needed to complete the purchase transaction. If the merchant is CDSTA non-compliant, the CDSTA software calls up the merchant's shopping cart and provide the selected items list, payment details and shipping preferences to conclude the transaction with that information. Once the customer has finished selecting items to purchase, the customer simply clicks the “Complete Purchase” button displayed on the CDSTA interface. The list of selected items for purchase is stored by the CDSTA for the independent automated purchase process.

Referring to FIG. 5E, the CDSTA 602 activates a cloud-secured request to transfer a credit amount to the customer's transaction account 210 from the concealed offline credit account and, if that amount of credit is available, then the credit amount is transferred to the transaction account and readied for disbursement to the merchant M. If the merchant is CDSTA compliant, the CDSTA submits a retail purchase order to the merchant along with all necessary details needed to complete the purchase transaction. If the merchant is CDSTA non-compliant, the CDSTA software calls up the merchant's shopping cart and provide the selected items list, payment details and shipping preferences to conclude the transaction with that information.

The merchant's requested payment amount is delivered to the bank's authorization server system 208 via the card processor transaction network 409. With the transaction account credited with the full credit amount, the bank's authorization server system compares the credit amount previously requested by the CDSTA 602′ to the payment amount requested from the merchant M via the card processor transaction network.

Referring to FIG. 5F, with all security measures verified, the bank's authorization server system 208 releases the credit amount to the card processor transaction network 409 for disbursement to the merchant's bank. Upon the completion of the transaction, the balance of available credit in the transaction account returns to zero.

The communication between the CDSTA, the merchant, card processor transaction network and the bank is preferably conducted at a cloud based security layer above SSL certification and is conducted independently from the customer's device.

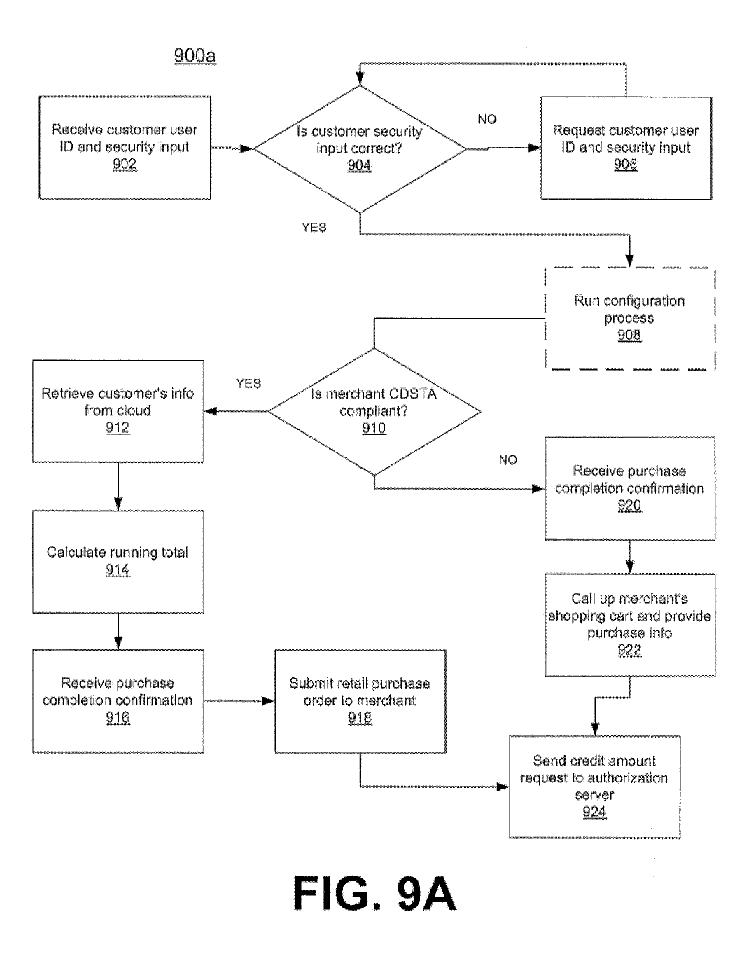

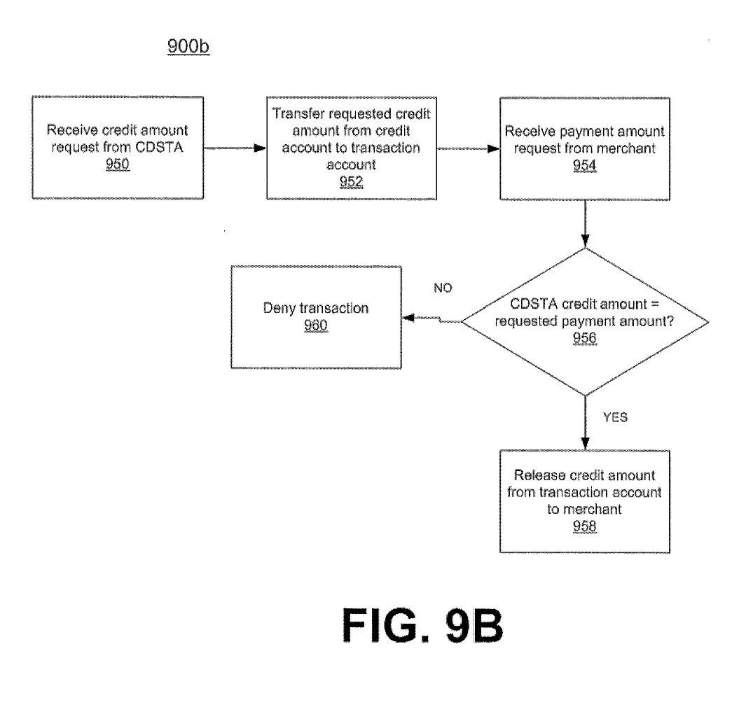

FIGS. 9A and 9B illustrate sample processes 900a and 900b that may be undertaken by the CDSTA and the bank authorization server system, respectively, with respect to this Example 4. First, the CDSTA receives the customer's login information which includes a user ID and a customer security input (902). The customer security input is in response to, for example, a PIN input request which consists of a character set and a prompt. The CDSTA then verifies the ID and customer security input (904).

If the user ID and customer security input are not correct, the CDSTA re-request this information (906). If the user ID and customer security input are correct, the CDSTA runs the one-time configuration process, if it has not been done previously (908). If the one-time configuration has been run previously, the CDSTA checks whether the merchant is CDSTA compliant (910).

If the merchant is CDSTA compliant, then the CDSTA retrieves the customer's information from the cloud (912) and calculates the running total of the customer's purchase while the customer selects items to purchase (914). When the CDSTA receives confirmation that the purchase has been completed (i.e. the customer has confirmed to purchase the item(s) selected) (916), the CDSTA submits the purchase order to the merchant. The CDSTA sends a credit amount request to the bank's authorization server (924).

If the merchant is not CDSTA compliant, then the CDSTA, once it receives a purchase completion confirmation (920), calls up the merchant's shopping cart and provide the necessary purchase information, as described above (922). The CDSTA then sends a credit amount request to the bank's authorization server (924).

Upon receipt of the credit amount request from the CDSTA (950), the authorization server transfers the requested credit amount from the credit account to the transaction account (952).

The authorization server receives a payment amount request from the merchant via the card processor transaction network (954). The authorization server checks whether the value of the requested credit amount is the same as that of the requested payment amount (956). If the values are the same, the authorization server releases the credit amount from the transaction account to the merchant via the card processor transaction network (958). If the values are different, the server denies the transaction (960).

Referring to FIG. 5G, the CDSTA 602′ can also be integrated into media delivery platforms allowing the customer to make one-click purchases in, for example, movies, on TV and/or in video games. Participating platforms such as game consoles 702 (e.g. xBox™ (Microsoft™ Corporation), Playstation™ (Sony Corporation), etc.), media players 704 (e.g. Blu-Ray™ players), television 706, cable boxes 708, computing devices 710, mobile devices 712, and satellite receivers 714 that subscribe to a standard, would require only that the CDSTA and PIN verification system to comply, allowing in-content purchases. The customer can use a mouse 720, remote control 722 or game controller 724 to select and purchase an item 726 seen in a movie, TV or video game and allow the CDSTA's automated transaction process to conclude the transaction.

In one embodiment, multiple devices may be associated with the same master transactional account number. For example, a credit card, a laptop, and a mobile phone may be linked to the same transactional account. The multiple devices may each have a unique concealed portion and/or PIN associated with the master account. Alternatively, the multiple devices may share the same concealed portion and/or PIN.

As will be apparent to those skilled in the art, various modifications, adaptations and variations of the foregoing specific disclosure can be made without departing from the scope of the invention claimed herein.

1. An authorization server system for secured processing of a credit payment, comprising:
at least one processor;
at least one memory component operatively connected to the at least one processor and storing a set of instructions executable by the at least one processor to cause the system to (a) receive a credit amount request and a customer security input from a customer interface device; (b) verify the customer security input; and, conditional upon verification, (c) debit an offline credit account by the credit amount and credit a zero balance transaction account by the credit amount.

2. The system of claim 1 wherein the instructions executable by the at least one processor further cause the system to (d) receive a second customer security input; (e) verify the second customer security input; and, conditional upon verification, (f) debit the transaction account by the credit amount and credit a merchant account by the credit amount.

3. The system of claim 2 wherein the second customer security input comprises data presenting the value of the credit amount, and verification of the second customer security input comprises the step of verifying the value of the credit amount equals the balance of the transaction account.

4. The system of claim 2 wherein either the first or the second customer security input, or both, is a response to a request comprising a character set having one or more characters and a prompt for a customer security input to complete or validate the character set.

5. The system of claim 1 wherein the transaction account is associated with a transaction account identifier comprising a string of characters, each character having a position in the string; wherein the character set comprises at least one character randomly selected from the transaction account identifier, and the customer security input comprises data representative of the position of the at least one randomly selected character within the transaction account identifier.

6. The system of claim 1 wherein the transaction account is associated with a PIN set comprising a string of characters; wherein the character set comprises at least one character randomly selected from the PIN set, and the customer security input is an input comprising a relative complement of the at least one character of the PIN set in the character set.

7. The system of claim 1 wherein the instructions executable by the at least one processor further cause the system to persistently store customer-related information in the at least one memory component.

8. The system of claim 1 wherein the instructions executable by the at least one processor further cause the system to display an interface on the customer interface device for receiving shopping information describing goods or services to be purchased in the credit transaction and the request for the credit amount.

9. The system of claim 1 wherein the instructions executable by the at least one processor further cause the system to transmit to the merchant server, customer-related information and shopping information describing goods or services to be purchased in the credit transaction, upon the receipt of the request for the credit amount by the credit request receiving unit and the verification of the customer security input by the customer security input verification unit.

10. The system of claim 1 wherein the instructions executable by the at least one processor further cause the system to credit a writable emergency line of credit memory component of a credit card in communication with the customer interface device with the value of the credit amount request.

11. The system of claim 1 wherein the memory component of the credit card is readable and writable by the customer interface device, the memory component having information about an amount debited against an emergency line of credit; and wherein the instructions executable by the at least one processor further cause the system to receive the amount debited against the emergency line of credit and (i) to debit the offline credit account by the amount debited against the emergency line of credit and (ii) to cause the customer interface device to reset the amount debited against the emergency line of credit stored on the credit card to zero, upon verification of the customer security input by the customer security input verification unit.

12. The system of claim 1 wherein the customer interface device is one or more of: a computing device, a mobile computing device, a game console, a media player, a television, a cable box, and a satellite receiver.

13. The system of claim 1 wherein the instructions executable by the at least one processor further cause the system to cause the customer interface device to display simultaneously a customer interface in communication with the system adjacent to a merchant interface in communication with the merchant server.

14. The system of claim 1 wherein the instructions executable by the at least one processor further cause the system to import customer-related information into a merchant interface in communication with the merchant server, to store a template of the merchant interface having the customer-related information, and to provide a short-cut to the template via the customer interface device.

15. A method for secured processing of a credit transaction, the method being implemented by an authorization server in communication via a network with a customer interface device and a merchant server, the method comprising:
(a) receiving from the customer interface device a credit request for a transaction account having a zero credit, the credit request comprising a credit amount and a customer security input;
(b) upon verification of the customer security input, debiting an offline credit account by the credit amount, and crediting the transaction account with the credit amount.

16. The method of claim 15 further comprising the step of receiving a second customer security input, and upon verification of the second customer security input, debiting the transaction account by the credit amount, and crediting a merchant account with the credit amount.

17. The method of claim 15 wherein the transaction account is associated with a transaction account identifier comprising a string of characters, each character having a position in the string; wherein either the first or second customer security input is a response to a character set which comprises at least one character randomly selected from the transaction account identifier, and the customer security input comprises data representative of the position of the at least one randomly selected character within the transaction account identifier.

18. The method of claim 15 wherein the transaction account is associated with a PIN set comprising a string of characters; wherein either the first or second customer security input is in response to a character set which comprises at least one character randomly selected from the PIN set, and the customer security input comprises data representative of a relative complement of the at least one character of the PIN set in the character set.

19. The method of claim 15 wherein the transaction account is associated with a PIN set comprising a plurality of characters, wherein either the first or second customer security input is in response to a character set which consists of at least one of but less than all of the characters of the PIN set, and the customer security input comprises data representative of the remaining characters in the PIN set.

20. The method of claim 15 further comprising the step of receiving from the merchant server a payment request for the merchant account, the payment request comprising a payment amount, and wherein one or both of: (i) debiting an offline credit account by the credit amount and crediting the transaction account with the credit amount; and (ii) debiting the transaction account by the credit and crediting the merchant account with the credit amount, are conditional upon verifying that the requested payment amount equals the requested credit amount.

21. The method of claim 15 further comprising the steps of:
persistently storing customer-related information;
providing for display by the customer interface device an interface enabling the customer to input shopping information describing goods or services to be purchased in the credit transaction, and to trigger the transmission of the shopping information and the credit request to the authorization server; and
in response to receiving the credit request, and conditional upon verifying the customer security input, transmitting to the merchant server the customer-related information and the shopping information.

22. The method of claim 15 further comprising the step of causing the customer interface device to display a customer interface adjacent to a merchant interface in communication with the merchant server.

23. The method of claim 15 further comprising the step of importing customer-related information into a merchant interface in communication with the merchant server; storing a template of the merchant interface having the customer-related information; and providing a short-cut to the template via the customer interface device.

24. A method for secured processing of an emergency credit card transaction, the method comprising:
providing a credit card with a physically integrated memory component for storing information about an amount debited against an emergency line of credit, wherein the memory component is readable and writable by a customer interface device;
receiving at an authorization server from the customer interface device via a network, the amount debited against the emergency line of credit as read from the memory component of the credit card, and a customer security input; and
verifying the customer security input; and
conditional upon verifying the customer security input:
(i) debiting an offline credit account by the amount debited against the emergency line of credit; and
(ii) resetting the amount debited against the emergency line of credit to zero.

25. A memory comprising a recording medium having recorded thereon instructions, which when executed by a processor of an authorization server system in communication via a network with a customer interface device and a merchant server causes the system to carry out a method for secured processing of a credit transaction, the method comprising:
(a) receiving from the customer interface device a credit request for a transaction account having a zero credit, the credit request comprising a credit amount and a customer security input;
(b) upon verification of the customer security input, debiting an offline credit account by the credit amount, and crediting the transaction account with the credit amount.

26. A memory comprising a recording medium having recorded thereon instructions, which when executed by a processor of an authorization server system in communication via a network with a customer interface device and a merchant server causes the system to carry out a method for secured processing of an emergency credit card transaction using a credit card with a physically integrated memory component for storing information about an amount debited against an emergency line of credit, wherein the memory component is readable and writable by the customer interface device, the method comprising:
receiving at the authorization server from the customer interface device via the network, the amount debited against the emergency line of credit as read from the memory component of the credit card, and a customer security input; and
verifying the customer security input; and
conditional upon verifying the customer security input:
(i) debiting an offline credit account by the amount debited against the emergency line of credit; and
(ii) resetting the amount debited against the emergency line of credit to zero.
